(19) United States
(12) Patent Application Publication
(10) Pub. No.: US 2008/0040408 A1
(43) Pub. Date: Feb. 14, 2008

(54) Temperature sampling in electronic devices

(76) Inventors: David Wyatt, San Jose, CA (US); Christopher Cox, Placerville, CA (US); Howard David, Portland, OR (US)

Correspondence Address: Caven & Aghevli LLC;c/o Intellevate, P.O. Box 52050, Minneapolis, MN, 55402, US

(21) Appl. No.: 11/502,235

(22) Filed: Aug. 10, 2006

(51) Int. Cl. G06F 7/00

(52) U.S. Cl. 708/204

(57) ABSTRACT

In some embodiments, an apparatus may comprise one or more memory modules, a memory controller, a communication bus to couple the one or more memory modules to the memory controller, and logic to detect a quiesce signal in one or more memory modules, initiate, in response to the quiesce signal, a temperature approximation routine, and set a temperature flag when the temperature approximation routine converges to a temperature approximation. Other embodiments may be described.

### BACKGROUND

The subject matter described herein relates generally to the field of electronics and more particularly to temperature sampling in electronic devices.

Electronic devices may benefit from accurate temperature sampling. For example, in many integrated circuit devices heat generation is proportional to the speed at which the integrated circuit is operated. Accurate temperature detection may permit designers of integrated circuit devices to develop control techniques that balance operating speeds with heat dissipation capabilities.

### BRIEF DESCRIPTION OF THE DRAWINGS

The detailed description is described with reference to the accompanying figures.

FIG. 1 is a schematic illustration of an exemplary computing device adapted to perform temperature sampling operations in accordance with some embodiments.

FIG. 2 is a schematic illustration an apparatus adapted to perform temperature sampling in accordance with some embodiments.

FIGS. 3A and 3B are schematic illustrations of signal processing logic for temperature sampling in accordance with some embodiments.

FIGS. 4-6 are flowcharts illustrating temperature sampling operations performed in accordance with some embodiments.

FIGS. 7-8 are schematic illustrations of approximation algorithms for temperature sampling in accordance with some embodiments.

FIG. 9 is a schematic illustration of a computing device in accordance with some embodiments.

### DETAILED DESCRIPTION

Described herein are exemplary systems and methods for temperature sampling in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

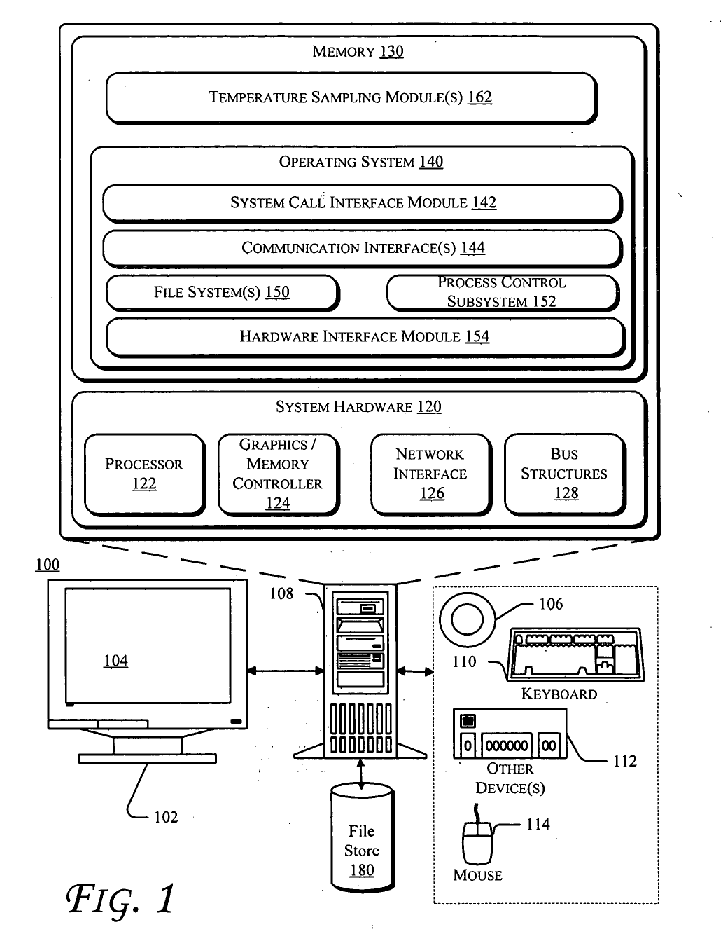

FIG. 1 is a schematic illustration of a computing system 100 adapted to perform temperature sampling operations according to some embodiments. In one embodiment, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics/memory controllers 124, network interfaces 126, and bus structures 128. In one embodiment, processor 122 may be embodied as an Intel® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics/memory controller 124 may function as an adjunct processor that manages graphics and/or video operations. Graphics/memory controller 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In various embodiments, the computing device 108 may be embodied as a personal computer, a laptop computer, a personal digital assistant, a mobile telephone, an entertainment device, or another computing device.

In one embodiment, memory 130 includes one or more temperature sampling modules 162 to manage temperature sampling operations in computing system 100. In one embodiment, a temperature sampling module 162 may include logic instructions encoded in a computer-readable medium which, when executed by processor 122 or graphics/memory controller 124, cause the processor 122 or graphics/memory controller 124 to implement temperature sampling operations.

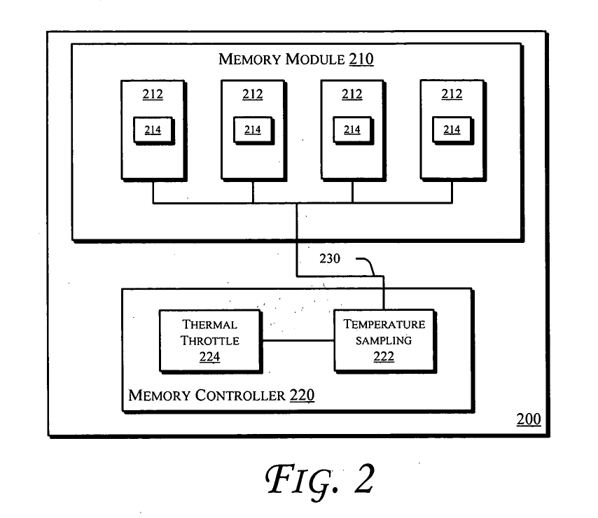

FIG. 2 is a schematic illustration an apparatus 200 adapted to perform temperature sampling in accordance with some embodiments. Referring to FIG. 2, apparatus 200 comprises a memory module 210 and a memory controller 220 coupled to the memory module 210 by a communication bus 230.

Memory module 210 comprises one or more memory devices 212, which may be embodied as random access memory devices such as, e.g., dual in-line memory modules (DIMMs), single in-line memory modules (SIMMs) or the like. Memory devices 212 comprise one or more temperature detectors 214 such as, e.g., a thermal diode, a thermocouple or the like. Temperature detectors 214 may be integrated onto the semiconductor die of memory devices 212 or may be constructed as a separate component.

Memory controller 220 may correspond to a portion of graphics/memory controller 124. In one embodiment memory controller 220 comprises a sensor processor module 222 and a temperature sampling module 224. Temperature sampling module 224 may correspond to temperature sampling module 162.

Communication bus 230 may be embodied as any suitable communication bus such as, e.g., a Peripheral Component Interconnect (PCI) bus, a PCI Express (PCIe) bus, an Industry Standard Architecture (ISA) bus, or the like.

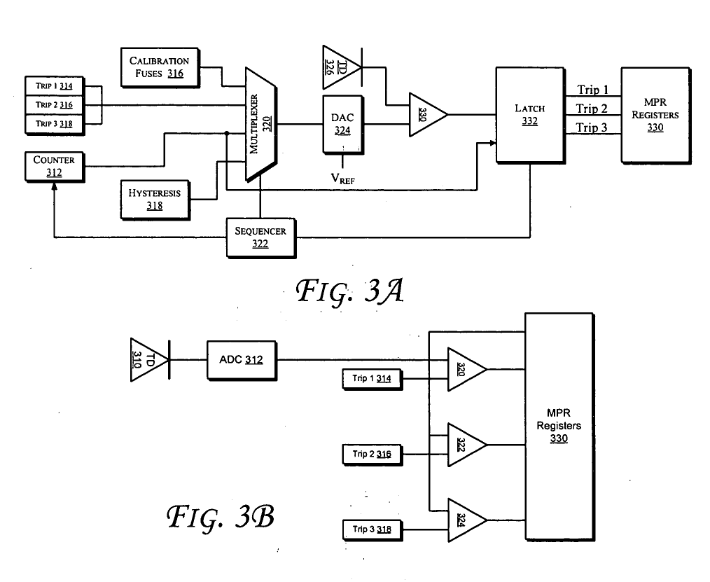

The one or more temperature detectors 214 generate electrical signals indicative of a temperature proximate the memory device(s) 212 to which the temperature detectors 214 are coupled. Temperature sampling module 222 may include logic to generate digital signals from the signal(s) generated by temperature detectors 214. FIGS. 3A and 3B are schematic illustrations of signal processing logic for temperature sampling in accordance with some embodiments.

A first embodiment is depicted in FIG. 3A. Referring first to FIG. 3A, a counter signal 312 and one or more trip signals 314, 316, 318 are input to a multiplexer 320. Multiplexer 320 may also receive input signals from one or more calibration fuses 316 and a hysteresis correction module 318 and a sequencer 322. The output from multiplexer 320 is input to a digital to analog converter (DAC) 324. Digital to analog converter (DAC) 324 may also receive a reference voltage V_{REF} as an input.

DAC 324 generates an output signal that is representative of one of inputs 314, 316, 318. A comparator 330 receives the output signal from DAC 324 and a signal from a temperature detector 326. The output from comparator is latched in latch 332 and eventually stored in memory protection registers (MPR) 330.

A second embodiment is depicted in FIG. 3B. Referring to FIG. 3B, a signal from thermal diode 310, which may correspond to one of the thermal detectors 214, is input to an analog to digital converter (ADC) 312, which outputs a digital signal representative of the analog signal generated by thermal diode 310. The digital signal output from ADC 312 is input to comparators 320, 322, 324 and to memory protection registers (MPR) 330. Each comparator 320, 322, 324 also receives an input voltage, referred to as a trip voltage, 314, 316, and 318, respectively. The output signals from comparators 320, 322, 324 are input to MPR 330.

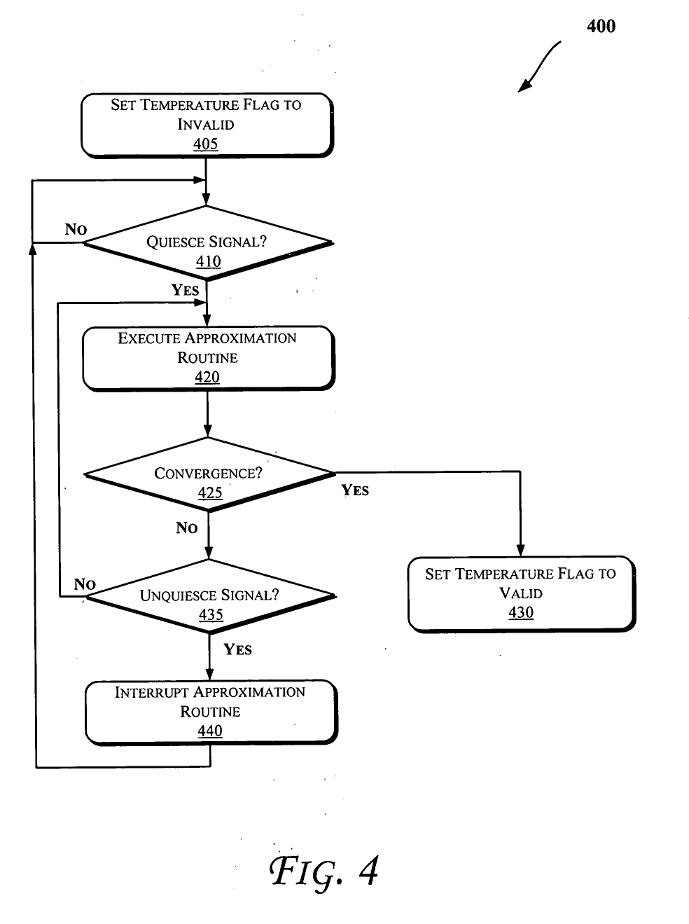

Data stored in the memory protections registers 330 may be used by temperature sampling module 222. FIGS. 4-6 are flowcharts illustrating temperature sampling operations performed in accordance with some embodiments. In one embodiment, the operations of FIGS. 4-6 may be implemented as logic instructions stored in a computer-readable medium such as, e.g., a memory module. Referring first to FIG. 4, at operation 405 a temperature flag is set to invalid. In some embodiments, the temperature flag may be stored in a suitable memory location.

In some embodiments, temperature sampling operations are conducted during time periods in which communication activity between one or more of the memory module(s) 212 and the memory controller 220 are quiesced. In some embodiments, memory bus 230 is monitored for a quiesce signal that directed to one or more of the memory modules. For example, some memory devices implement a quiesce cycle on a periodic basis to perform impedance calibration. In other embodiments, the quiesce cycle may be initiated specifically to implement a temperature sampling routine.

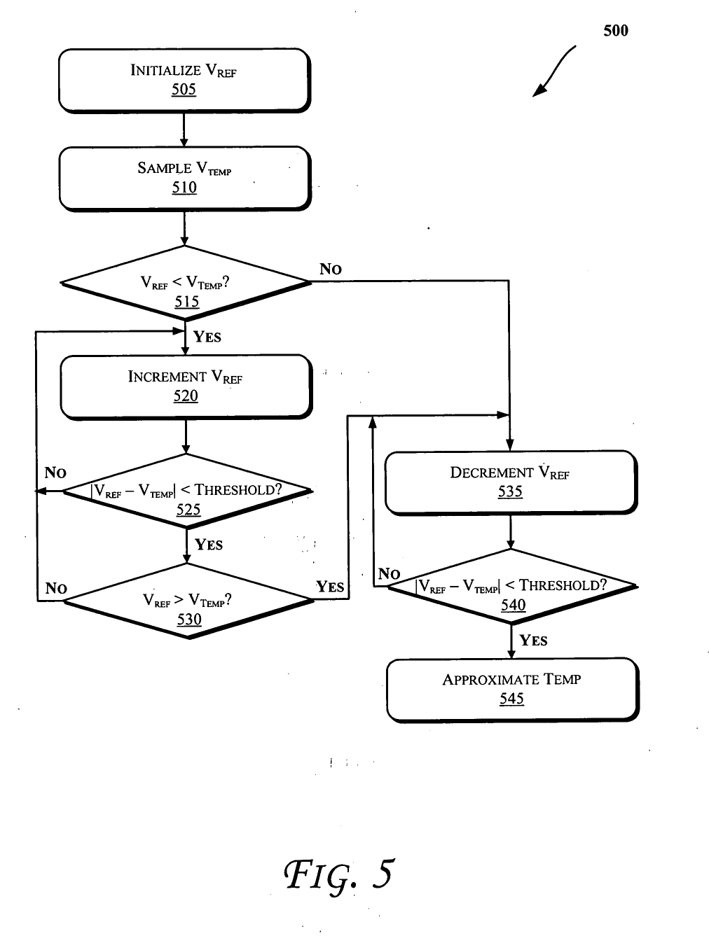

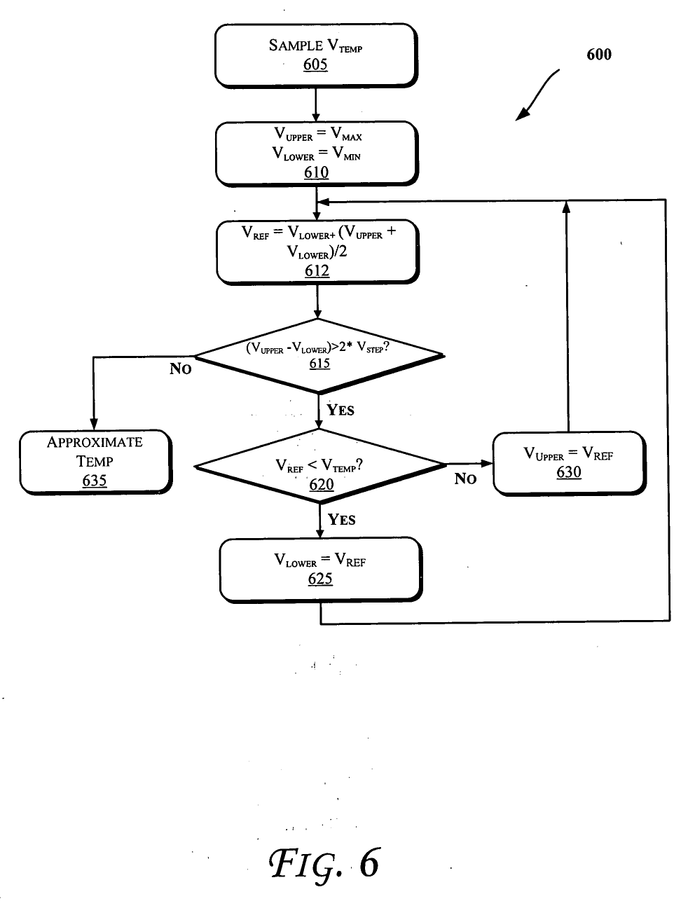

If, at operation 410, a quiesce signal is not detected then control remains with operation 410. By contrast, if at operation 410 a quiesce signal is detected, then control passes to operation 420 and a temperature approximation routine is executed. Embodiments of temperature approximation routines are described below with reference to FIGS. 5-6.

If, at operation 425 the temperature approximation routine has converged to a temperature approximation, then control passes to operation 430 and the temperature flag is set to a value that indicates the temperature reading for the sampled memory module(s) is valid. By contrast, if at operation 425 the temperature convergence routing has not converged to a temperature approximation, then control passes to operation 435.

If, at operation 435, no unquiesce signal is detected on communication bus 230, then control passes back to operation 420 and the approximation routine continues execution. By contrast, if at operation 435 an unquiesce signal is detected on communication bus 230, then control passes to operation 440 and the temperature approximation routine is interrupted. Control then passes back to operation 410 and the communication bus is monitored for another quiesce signal.

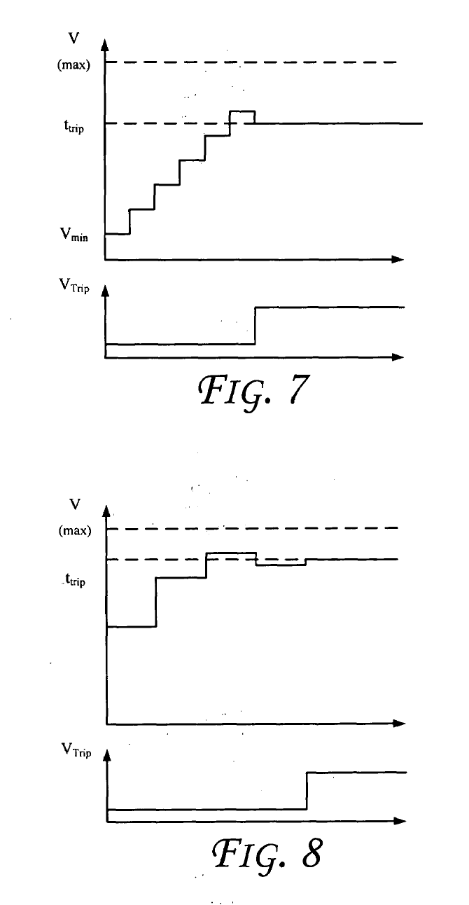

FIG. 5 is a flowchart illustrating operations in one embodiment of a temperature approximation routine that implements a successive approximation algorithm, and FIG. 7 is graphical depiction of the temperature approximation algorithm of FIG. 5. Referring to FIG. 5, at operation 505 a reference voltage V_{REF} is initialized to a minimum voltage level V_{MIN}. At operation 510 a voltage reading is taken from a temperature detector 214.

If, at operation 515, the voltage V_{REF} is less than a voltage V_{TEMP} generated by the temperature detector 214 sampled in operation 510, then control passes to operation 520 and the reference voltage V_{REF} is incremented. In some embodiments, V_{REF} is incremented by a fixed amount such as, e.g., 0.5 volts.

If, at operation 525 the difference between the reference voltage V_{REF} and the voltage V_{TEMP} generated by the temperature detector 214 is not less than a threshold value, then control passes back to operation 520 and the reference voltage V_{REF} is incremented. The threshold may be fixed or dynamic, and may be an absolute voltage value or may be a percentage of the voltage range of the electronic device. Operations 520-525 are repeated until at operation 525 the difference between the reference voltage V_{REF} and the voltage V_{TEMP} generated by the temperature detector 214 is less than a threshold value, then control passes to operation 530.

If, at operation 530, the voltage V_{REF} is greater than a voltage V_{TEMP} generated by the temperature detector 214 sampled in operation 510, then control passes to operation 535 and the reference voltage V_{REF} is decremented. In some embodiments, V_{REF} is decremented by a fixed amount such as, e.g., 0.25 volts.

If, at operation 540 the difference between the reference voltage V_{REF} and the voltage V_{TEMP} generated by the temperature detector 214 is not less than a threshold value, then control passes back to operation 535 and the reference voltage V_{REF} is decremented. The threshold may be fixed or dynamic, and may be an absolute voltage value or may be a percentage of the voltage range of the electronic device. Operations 535-540 are repeated until at operation 540 the difference between the reference voltage V_{REF} and the voltage V_{TEMP} generated by the temperature detector 214 is less than a threshold value, then control passes to operation 545 and the voltage V_{TEMP} is approximated as the voltage V_{REF}.

FIG. 6 is a flowchart illustrating operations in one embodiment of a temperature approximation routine that implements a binary approximation algorithm, and FIG. 8 is graphical depiction of the temperature approximation algorithm of FIG. 6. Referring to FIG. 6, operation 605 a voltage reading is taken from a temperature detector 214. At operation 610 upper and lower voltage limits for the approximation routine are set. In the embodiment depicted in FIG. 6 the upper limit V_{UPPER} is set to the maximum voltage V_{MAX} of the electronic device, and the lower limit V_{LOWER} is set to the minimum voltage V_{MIN} of the electronic device.

At operation 612 a reference voltage V_{REF} is calculated. If, at operation 615, the difference between the upper voltage limit voltage V_{UPPER} and the lower voltage limit V_{LOWER} is less than twice a voltage increment V_{STEP}, then control passes to operation 635 and the temperature is approximated. In some embodiments, the temperature may be approximated by first setting the voltage V_{TEMP} equal to the voltage V_{REF}, then transforming the voltage reading back to a temperature.

By contrast, if at operation 615 the difference between the upper voltage limit voltage V_{UPPER} and the lower voltage limit V_{LOWER} is not less than twice a voltage increment V_{STEP}, then control passes to operation 620.

If, at operation 620 the reference voltage V_{REF} is less than the voltage V_{TEMP} generated by the temperature detector 214, then control passes to operation 625 and the lower voltage limit V_{LOWER} is set to the reference voltage V_{REF}. By contrast, if at operation 620 the reference voltage V_{REF} is not less than the voltage V_{TEMP} generated by the temperature detector 214, then control passes to operation 625 and the lower voltage limit V_{UPPER} is set to the reference voltage V_{REF}. Control then passes back to operation 612.

Operations 612-635 are repeated until at operation 615, the difference between the upper voltage limit voltage V_{UPPER} and the lower voltage limit V_{LOWER} is less than twice a voltage increment V_{STEP}.

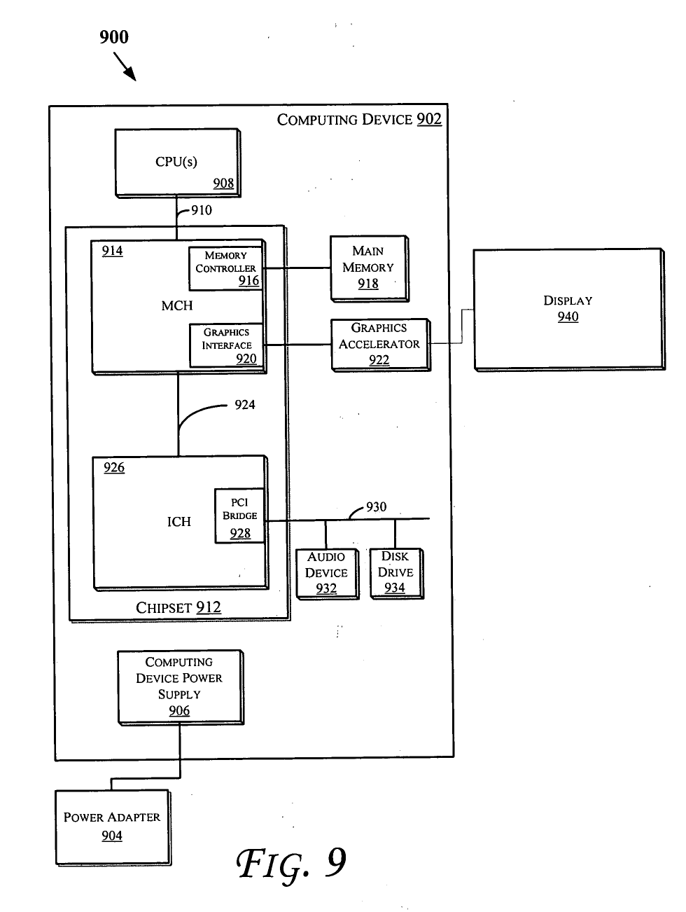

FIG. 9 is a schematic illustration of a computer system 900 in accordance with some embodiments. The computer system 900 includes a computing device 902 and a power adapter 904 (e.g., to supply electrical power to the computing device 902). The computing device 902 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 902 (e.g., through a computing device power supply 906) from one or more of the following sources: one or more battery packs, an alternating current (AC) outlet (e.g., through a transformer and/or adaptor such as a power adapter 904), automotive power supplies, airplane power supplies, and the like. In some embodiments, the power adapter 904 may transform the power supply source output (e.g., the AC outlet voltage of about 110 VAC to 240 VAC) to a direct current (DC) voltage ranging between about 7 VDC to 12.6 VDC. Accordingly, the power adapter 904 may be an AC/DC adapter.

The computing device 902 may also include one or more central processing unit(s) (CPUs) 908 coupled to a bus 910. In some embodiments, the CPU 908 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 912 may be coupled to the bus 910. The chipset 912 may include a memory control hub (MCH) 914. The MCH 914 may include a memory controller 916 that is coupled to a main system memory 918. The main system memory 918 stores data and sequences of instructions that are executed by the CPU 908, or any other device included in the system 900. In some embodiments, the main system memory 918 includes random access memory (RAM); however, the main system memory 918 may be implemented using other memory types such as dynamic RAM (DRAM), synchronous DRAM (SDRAM), and the like. Additional devices may also be coupled to the bus 910, such as multiple CPUs and/or multiple system memories.

The MCH 914 may also include a graphics interface 920 coupled to a graphics accelerator 922. In some embodiments, the graphics interface 920 is coupled to the graphics accelerator 922 via an accelerated graphics port (AGP). In some embodiments, a display (such as a flat panel display) 940 may be coupled to the graphics interface 920 through, for example, a signal converter that translates a digital representation of an image stored in a storage device such as video memory or system memory into display signals that are interpreted and displayed by the display. The display 940 signals produced by the display device may pass through various control devices before being interpreted by and subsequently displayed on the display.

A hub interface 924 couples the MCH 914 to an input/output control hub (ICH) 926. The ICH 926 provides an interface to input/output (I/O) devices coupled to the computer system 900. The ICH 926 may be coupled to a peripheral component interconnect (PCI) bus. Hence, the ICH 926 includes a PCI bridge 928 that provides an interface to a PCI bus 930. The PCI bridge 928 provides a data path between the CPU 908 and peripheral devices. Additionally, other types of I/O interconnect topologies may be utilized such as the PCI Express™ architecture, available through Intel® Corporation of Santa Clara, Calif.

The PCI bus 930 may be coupled to an audio device 932 and one or more disk drive(s) 934. Other devices may be coupled to the PCI bus 930. In addition, the CPU 908 and the MCH 914 may be combined to form a single chip. Furthermore, the graphics accelerator 922 may be included within the MCH 914 in other embodiments.

Additionally, other peripherals coupled to the ICH 926 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 902 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus, comprising:
one or more memory modules;
a memory controller;
a communication bus to couple the one or more memory modules to the memory controller; and
logic to:
detect a quiesce signal in one or more memory modules;
initiate, in response to the quiesce signal, a temperature approximation routine; and
set a temperature flag when the temperature approximation routine converges to a temperature approximation.

2. The apparatus of claim 1, wherein:
the one or more memory modules comprise one or more memory devices; and
the one or more memory devices comprise one or more temperature detectors.

3. The apparatus of claim 2, further comprising:
logic to convert a voltage signal generated by the one or more temperature detectors to a digital signal; and
logic to compare the digital signal to one or more trip values.

4. The apparatus of claim 1, wherein the quiesce signal is originated by the memory controller to quiesce operations on the memory bus.

5. The apparatus of claim 1, wherein the temperature approximation routine compares a voltage generated by a temperature detecting device to one or more reference voltages.

6. The apparatus of claim 1, further comprising logic to:
detect an unquiesce signal; and
interrupt the temperature approximation routine in response to the unquiesce signal.

7. The apparatus of claim 1, further comprising logic to:
detect a quiesce signal; and
restart the temperature approximation routine in response to the quiesce signal.

8. The apparatus of claim 1, further comprising logic to adjust an operating parameter of the memory module in response an output of the temperature approximation routine.

9. A method, comprising:
detecting a quiesce signal in one or more memory modules;
initiating, in response to the quiesce signal, a temperature approximation routine; and
setting a temperature flag when the temperature approximation routine converges to a temperature approximation.

10. The method of claim 9, wherein the quiesce signal is originated by a memory controller to quiesce operations on a memory bus.

11. The method of claim 9, wherein the temperature approximation routine compares a voltage generated by a temperature detecting device to one or more reference voltages.

12. The method of claim 9, further comprising:
detecting an unquiesce signal; and
interrupting the temperature approximation routine in response to the unquiesce signal.

13. The method of claim 12, further comprising:
detecting a quiesce signal; and
restarting the temperature approximation routine in response to the quiesce signal.

14. The method of claim 9, further comprising adjusting an operating parameter of the memory module in response an output of the temperature approximation routine.

15. A method, comprising:
initiating a temperature approximation routine during a quiesce cycle in a memory module; and
setting a temperature flag when the temperature approximation routine converges to a temperature approximation.

16. The method of claim 15, wherein the quiesce cycle is originated by a memory controller to quiesce operations on a memory bus in the memory module.

17. The method of claim 16, wherein the temperature approximation routine compares a voltage generated by a temperature detecting device to one or more reference voltages.

18. The method of claim 15, further comprising:
interrupting the temperature approximation routine in response to a termination of the quiesce cycle.

19. The method of claim 15, further comprising:
restarting the temperature approximation routine during a subsequent quiesce cycle.

20. The method of claim 15, further comprising adjusting an operating parameter of the memory module in response an output of the temperature approximation routine.

21. A system, comprising:
a processor;
a display;
one or more memory modules;
a memory controller;
a communication bus to couple the one or more memory modules to the memory controller; and
logic to:
detect a quiesce signal in one or more memory modules;
initiate, in response to the quiesce signal, a temperature approximation routine; and
set a temperature flag when the temperature approximation routine converges to a temperature approximation.

22. The system of claim 21, wherein:
the one or more memory modules comprise one or more memory devices; and
the one or more memory devices comprise one or more temperature detectors.

23. The system of claim 22, further comprising:
logic to convert a voltage signal generated by the one or more temperature detectors to a digital signal; and
logic to compare the digital signal to one or more trip values.

24. The system of claim 21, wherein the quiesce signal is originated by the memory controller to quiesce operations on the memory bus.
